(19) United States
(12) Patent Application Publication
(10) Pub. No.: US 2014/0179379 A1
(43) Pub. Date: Jun. 26, 2014

(54) MODE CHANGE APPARATUS AND METHOD IN ELECTRONIC DEVICE

(71) Applicant: Samsung Electronics Co., Ltd., Gyeonggi-do (KR)

(72) Inventors: Sung-Ho SON, Daegu (KR); Yang-Su Kim, Gyeonggi-do (KR); Su-Young Park, Gyeonggi-do (KR); Keum-Ju Jang, Seoul (KR)

(73) Assignee: Samsung Electronics Co., Ltd., Gyeonggi-do (KR)

(21) Appl. No.: 14/108,905

(22) Filed: Dec. 17, 2013

(30) Foreign Application Priority Data
Dec. 24, 2012 (KR) 10-2012-0152336

(51) Int. Cl. H04M 3/02; G06K 9/00; H04W 4/16

(52) U.S. Cl. CPC H04M 3/02; H04W 4/16; G06K 9/00221
USPC 455/567

(57) ABSTRACT

A mode change apparatus and method using face recognition in an electronic device are provided. The method of changing a notifying mode includes, determining whether a face is recognized from surroundings of the electronic device when a call is received; and generating a call reception event in a first notification mode when the face is recognized from the peripheral images.

### PRIORITY

This application claims priority under 35 U.S.C. §119 to an application filed in the Korean Intellectual Property Office on Dec. 24, 2012 and assigned Serial No. 10-2012-0152336, the content of which is incorporated herein by reference.

### BACKGROUND OF THE INVENTION

1. Field of the Invention

The present invention relates generally to an electronic device, and more particularly, to a mode change apparatus and method in an electronic device.

2. Description of the Related Art

As mobile communication technologies have developed, mobile electronic devices have become essential to individuals. Furthermore, since the mobile electronic devices provide not only a voice call function but also various additional functions such as camera, data communication, audio playback, and messenger functions, use of the mobile electronic devices has increased.

As the use of the mobile electronic devices increases, side effects stemming therefrom also increase. For example, users of the mobile electronic devices may cause noise pollution with their ringtones in public places such as an office, a theater, and public transportation stations.

Accordingly, the mobile electronic devices may provide a manner mode function for changing a notification mode into a vibration mode in order to reduce the noise pollution caused by the ringtones. However, a user is inconvenienced when manually setting the manner modes of the mobile electronic devices. In addition, the mobile electronic devices may negatively impact their surroundings with noises resulting from the generation of the vibration.

### SUMMARY OF THE INVENTION

The present invention has been made to address at least the above problems and/or disadvantages and to provide at least the advantages below. Accordingly, aspects of the present invention provide a mode change apparatus and method in an electronic device.

Another aspect of the present invention provides an apparatus and method for performing a mode change through face recognition in an electronic device.

Another aspect of the present invention provides an apparatus and method for automatically changing a call reception notifying mode into a silent mode in an electronic device.

Another aspect of the present invention provides an apparatus and method for automatically changing a call reception notifying mode into a silent mode through face recognition in an electronic device.

According to an aspect of the present invention, a method of operating an electronic device is provided. The method includes determining whether a face is recognized from surroundings of the electronic device when a call is received; and generating a first call reception event in a first notification mode when the face is recognized from the peripheral images.

According to another aspect of the present invention, an electronic device is provided. The electronic device includes a communication system, a camera; and at least one processor, wherein, when a call is received, the processor determines whether a face is recognized in images obtained by the camera, and wherein, when the face is recognized from the images, the processor generates a first call reception event in a first notification mode.

### BRIEF DESCRIPTION OF THE DRAWINGS

The above and other objects, features and advantages of the present invention will become more apparent from the following detailed description when taken in conjunction with the accompanying drawings in which:

FIG. 1 illustrates a block configuration of an electronic device according to an embodiment of the present invention;

FIG. 2 illustrates a block configuration of a processor according to an embodiment of the present invention;

FIG. 3 illustrates a procedure for performing a mode change through face recognition in an electronic device according to an embodiment of the present invention;

FIG. 4 illustrates a procedure for changing a call reception notifying mode through face recognition in an electronic device according to an embodiment of the present invention;

FIG. 5 illustrates a procedure for changing a call reception notifying mode through face recognition in an electronic device according to another embodiment of the present invention;

FIGS. 6A and 6B illustrate screen configurations for changing a call reception notifying mode through face recognition in an electronic device according to an embodiment of the present invention;

FIG. 7 illustrates a procedure for terminating an alarm through face recognition in an electronic device according to an embodiment of the present invention;

FIG. 8 illustrates a procedure for terminating an alarm through face recognition in an electronic device according to an embodiment of the present invention; and;

FIGS. 9A and 9B illustrate screen configurations for terminating an alarm through face recognition in an electronic device according to an embodiment of the present invention.

### DETAILED DESCRIPTION OF THE EMBODIMENTS OF THE PRESENT INVENTION

Various embodiments of the present invention will be described herein below with reference to the accompanying drawings. In the following description, detailed descriptions of well-known functions or constructions will be omitted since they would obscure the invention in unnecessary detail. Also, the terms used herein are defined according to the functions of the present invention. Thus, the terms may vary depending on a user or operator's intentions or practices. Therefore, the terms used herein must be understood based on the descriptions made herein.

Hereinafter, different embodiments of the present invention will be described in detail by explaining a technology for changing a mode using face recognition in an electronic device.

In the description below, an electronic device may include a mobile communication terminal including, for example, a camera, a personal digital assistant (PDA), a Personal Computer (PC), a laptop computer, a smart phone, a net book computer, a television, a Mobile Internet Device (MID), an Ultra Mobile PC (UMPC), a tablet PC, a navigation device, a wrist watch, a smart TV, and a Motion Picture experts group layer-3 (MP3) player.

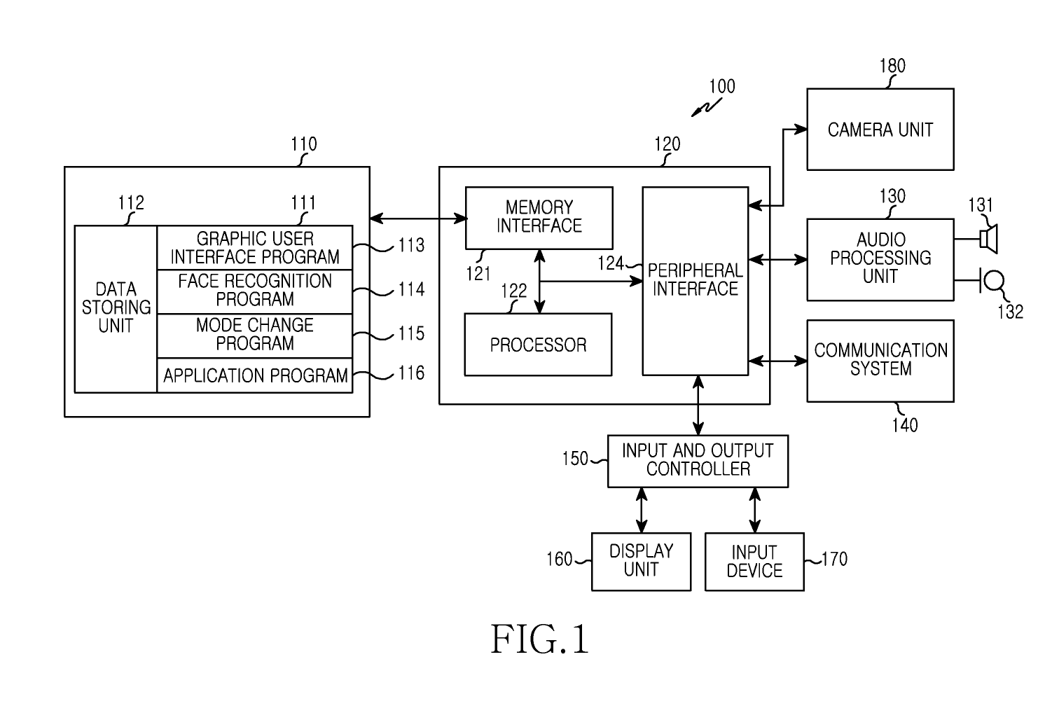

FIG. 1 illustrates a block configuration of an electronic device according to an embodiment of the present invention.

As illustrated in FIG. 1, the electronic device 100 may include a memory 110, a processor unit 120, an audio processing unit 130, a communication system 140, an input and output controller 150, a display unit 160, an input device 170, and a camera unit 180. It should be noted that the electronic device 100 may include more than one memory 110.

The memory 110 includes a program storing unit 111 storing programs for controlling operations of the electronic device 100, and a data storing unit 112 for storing data generated during execution of the programs

The data storing unit 112 stores reference information for face recognition. Here, the reference information may include, for example, information pertaining to a face of a user of the electronic device 100.

The program storing unit 111 may include a Graphical User Interface (GUI) program 113, a face recognition program 114, a mode change program 115, and at least one application program 116. Herein, the programs stored in the program storing unit 111 may be represented as instruction sets, which are sets of instructions that are carried out by a processor.

The GUI program 113 may include at least one software element for providing a user interface graphically on the display unit 160. For example, the GUI program 113 controls the electronic device 100 to display information pertaining to the application programs driven by the processor 122 on the display unit 160. The GUI program 113 controls the electronic device 100 to display information pertaining a mode change executed by the mode change program 115 on the display unit 160.

The face recognition program 114 may include at least one software element for performing face recognition on an image obtained through the camera unit 180. Specifically, the face recognition program 114 extracts face regions from the image obtained by the camera unit 180. Then the face recognition program 114 recognizes a face included in the image by detecting elements such as eyes, a nose, and a mouth included in the face region. For example, the face recognition program 114 may extract the face regions in the image obtained by the camera unit 180 using information such as, for example, brightness, motion, color, or eye position estimation, etc. Then, the face recognition program 114 detects feature points of a face such as the eyes, the nose, and the mouth included in the face region, and recognizes the face included in the image by comparing positions and sizes of the feature points, and distances between the feature points included in the image with the reference information stored in the data storing unit 112.

The mode change program 115 may include at least one software element for changing an operation mode of the electronic device 100 as a function of face recognition information using the face recognition program 114. For example, when a call is received, the mode change program 115 may activate the camera unit 180 to perform face recognition. If a face is recognized from the image obtained by the camera unit 180 by using the face recognition program 114, the mode change program 115 may change a call reception notifying mode to a silent mode.

In another example, when the pupils are recognized in an image obtained by the camera unit 180 using the face recognition program 114, the mode change program 115 may change a call reception notifying mode to a silent mode.

In yet another example, when a face of a user of the electronic device 100 is recognized from an image obtained by the camera unit 180 by using the face recognition program 114, the mode change program 115 may change a call reception notifying mode to a silent mode.

In yet another example, when an alarm is generated by an alarm event, the mode change program 115 may activate the camera unit 180 to perform face recognition. When a face is recognized in an image obtained by the camera unit 180 using the face recognition program 114, the mode change program 115 may terminate the alarm.

In another example, when the pupils are recognized in an image obtained by the camera unit 180 using the face recognition program 114, the mode change program 115 may terminate the alarm.

In yet another example, when a face is continuously detected for a predetermined time period using the face recognition program 114, the mode change program 115 may terminate the alarm.

In yet another example, when a face of a user of the electronic device 100 is recognized in an image obtained by the camera unit 180 using the face recognition program 114, the mode change program 115 may terminate the alarm.

The application program 116 may include software elements for at least one application program installed in the electronic device 100.

The processor unit 120 includes a memory interface 121, at least one processor 122, and a peripheral device interface 124. Here, the memory interface 121, the at least one processor 122, and the peripheral device interface 124 included in the processor unit 120 may be implemented to be integrated into at least one integrated circuit or as separate elements.

The memory interface 121 controls access by elements, such as the processor 122 or the peripheral device interface 124, to the memory 110.

The peripheral device interface 124 controls connections of the input and output peripheral devices of the electronic device 100 to the processor 122 and the memory interface 121.

The processor 122 controls the electronic device 100 enabling it to provide various multimedia services using at least one software program. Here, the processor 122 may execute at least one program stored in the memory 110 to provide a service corresponding to the executed program. For example, the processor 122 may execute the mode change program 115 stored in the program storing unit 111 and control the electronic device 100 to change an operation mode of the electronic device 100.

The processor 122 may also execute the face recognition program 114 stored in the program storing unit 111 and control the electronic device 100 to change the operation mode of the electronic device 100 in consideration of the recognized face information.

The audio processing unit 120 provides an audio interface between a user and the electronic device 100 through a speaker 131 and a microphone 132.

The communication system 140 performs a communication function for voice and data communications. The communication system 140 may be divided into a plurality of communication sub-modules supporting different communication networks. For example, the communication network may include, but is not limited to, a Global System for Mobile communications (GSM) network, an Enhanced Data for Global Evolution (EDGE) network, a Code-Division Multiple Access (CDMA) network, a Wideband-CDMA (W-CDMA) network, a Long Term Evolution (LTE) network, an Orthogonal Frequency-Division Multiple Access (OFDMA) network, a wireless Local Area Network (LAN), a Bluetooth network, and a Near Field Communication (NFC) network, etc.

The input and output controller 150 may provide interfaces between input and output devices, such as the display unit 160 and the input device 170, and the peripheral device interface 124.

The display unit 160 displays state information regarding the electronic device 100, letters input by a user, moving pictures, and still images. For example, the display unit 160 may display information regarding application programs driven by the processor 122. The display unit 160 may also display information regarding a mode change performed by the mode change program 115 according to control of the GUI program 113.

The input unit 170 may provide input data, created by a user's selection, to the processor unit 120 through the input and output controller 150. The input unit 170 may include, for example, a keypad including at least one hardware button, and a touch pad sensing touch information. For example, the input unit 170 may provide the touch information sensed by the touch pad to the processor 122 through the input and output controller 150.

The camera unit 180 provides images collected by capturing subjects using a camera lens. For example, the camera unit 180 may include a camera sensor converting an optical signal into an electrical signal, an image processor converting an analog image signal into a digital image signal, and a signal processor processing an image signal and allowing the image signal output from the image processor to be displayed on the display unit 160. Here, the camera sensor may be a Charge-Coupled Device (CCD) sensor or a Complementary Metal-Oxide-Semiconductor (CMOS) sensor, and the signal processor may be implemented as a Digital Signal Processor (DSP).

The camera unit 180 may include a first camera (not shown) positioned at a front surface of the electronic device 100 and a second camera (not shown) positioned at a rear surface of the electronic device 100. In this case, when a notification event occurs, the mode change program 115 may activate the first camera in order to obtain an image for face recognition.

In the above-described embodiment, the processor 122 may execute software elements stored in the program storing unit 111 to control an operation mode of the electronic device 100 to be changed in a single module.

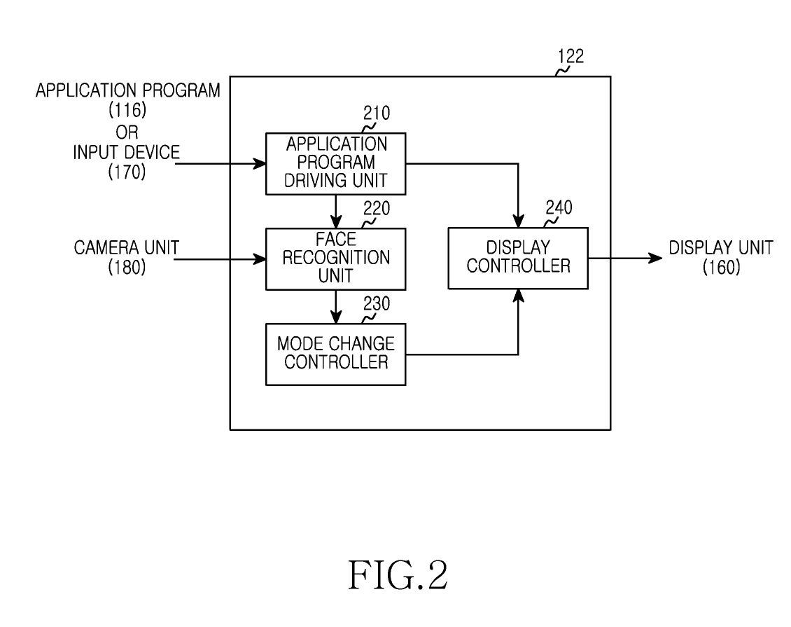

In another embodiment, the processor 122, as described below with regards to FIG. 2, may be configured to include elements for controlling the electronic device 100 to change an operation mode as separate modules.

FIG. 2 illustrates a detailed block configuration of a processor according to an embodiment of the present invention.

As illustrated in FIG. 2, the processor 122 may include an application program driving unit 210, a face recognition unit 220, a mode change controller 230, and a display controller 240.

The application program driving unit 210 executes at least one application program 116 stored in the program storing unit 111 to provide a service corresponding to the executed application program. For example, the application program driving unit 200 may execute a communication application program stored in the program storing unit 111 to provide a communication service. In another example, the application program driving unit 200 may execute an alarm application program stored in the program storing unit 111 to provide an alarm service.

The face recognition unit 220 performs face recognition on an image obtained by the camera unit 180. The face recognition unit 220 may execute the face recognition program 114 stored in the program storing unit 111 to perform face recognition on the image obtained by the camera unit 180. Specifically, the face recognition unit 220 may extract a face region from the image obtained by the camera unit 180. Then, the face recognition unit 220 may recognize a face included in the image as a function of elements, such as eyes, a nose, a mouth, etc., included in the face region. For example, the face recognition unit 220 may extract the face region from the image obtained by the camera unit 180 by using information regarding brightness, motion, color, and eye position estimation, etc. Then the face recognition unit 220 may detect feature points of a face, such as eyes, a nose, and a mouth included in the face region, and compare positions, sizes, and distances between the feature points included in the image with the reference information stored in the data storing unit 112 to recognize the face included in the image.

The mode change controller 230 may change an operation mode of the electronic device 100 as a function of face recognition information obtained by the face recognition unit 220. The mode change controller 230 may change the operation mode of the electronic device 100 by executing the mode change program 115 stored in the program storing unit 111 as a function of the face recognition information obtained by the face recognition unit 220. For example, when a call is received, the mode change controller 230 may activate the camera unit 180 in order to perform face recognition. When the face recognition unit 220 recognizes a face from an image obtained by the camera unit 180, the mode change controller 230 may change a call reception notifying mode to a silent mode.

In another example, when the face recognition unit 220 recognizes the pupils in an image obtained by the camera unit 180, the mode change controller 230 may change a call reception notifying mode to a silent mode.

In yet another example, when an alarm is generated by an alarm event, the mode change controller 230 may activate the camera unit 180 to perform face recognition. When the face recognition unit 220 recognizes a face in an image obtained by the camera unit 180, the mode change controller 230 may terminate the alarm.

In yet another example, when the face recognition unit 220 recognizes the pupils in an image obtained by the camera unit 180, the mode change controller 230 may terminate the alarm.

In yet another example, when the face recognition unit 220 continuously detects and recognizes a face for a predetermined time period, the mode change controller 230 may terminate alarm.

In yet another example, when the face recognition unit 220 recognizes a face of a user of the electronic device 100 in an image obtained by the camera unit 180, the mode change controller 230 may terminate the alarm.

The display controller 240 executes the GUI program 113 stored in the program storing unit 111 to display the user interface on the display unit 160. For example, the display controller 240 may control information on an application program driven by the application program driving unit 210 to be displayed on the display unit 160. The display controller 240 may control information regarding a mode change performed by the mode change controller 230 to be displayed on the display unit 160.

As described above, the electronic device 100 can change the call reception notifying mode to the silent mode as a function of face recognition information. The electronic device 100 may temporarily change the call reception notifying mode to the silent mode or a setting of the call reception notifying mode to the silent mode.

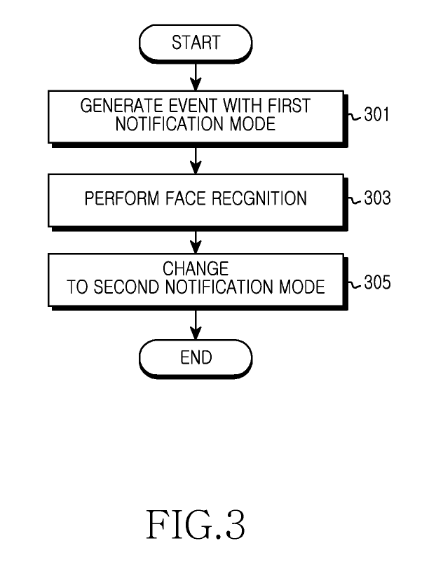

FIG. 3 illustrates a procedure of changing the call reception notifying mode through face recognition in an electronic device according to an embodiment of the present invention.

Referring to FIG. 3, when a notification event occurs in operation 301, the electronic device may indicate notification event information according to a first notification mode. For example, when the call is received, the electronic device may generate a ringtone for indicating the call reception information according to a preset ringtone mode. In another example, when a call is received, the electronic device may generate a vibration for indicating the call reception information according to a preset vibration mode. In another example, when the alarm event occurs, the electronic device may generate an alarm sound.

In step 303, the electronic device performs face recognition on an image obtained by the camera unit.

When the face recognition is performed, the electronic device, in step 305, recognizes a face from the image obtained by the camera unit and changes a notification mode to a second notification mode. For example, when a face is recognized in an image obtained by the camera unit, the electronic device may change the ringtone mode or vibration mode for indicating the call reception information to the silent mode. In another example, when the face is recognized from the image obtained by the camera unit, the electronic device may terminate the notification mode.

In the above-described embodiments, when the notification event occurs, the electronic device indicates notification event information according to the first notification mode, and then changes the notification mode to the second notification mode on the basis of the face recognition information.

In another embodiment, when the notification event occurs, the electronic device determines whether the notification mode should be changed to the second notification mode on the basis of the face recognition information. If a mode change to the second notification mode is not performed, the electronic device may relay the notification event information according to the first notification mode.

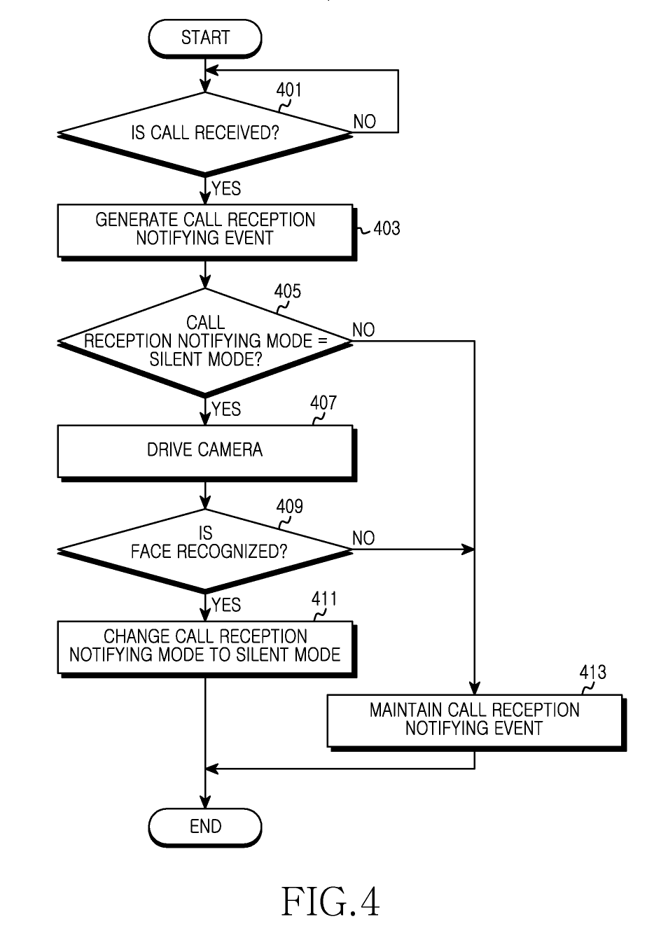

FIG. 4 illustrates a procedure of changing a call reception notifying mode through face recognition in an electronic device according to an embodiment of the present invention.

Referring to FIG. 4, in step 401 the electronic device determines whether a call is received.

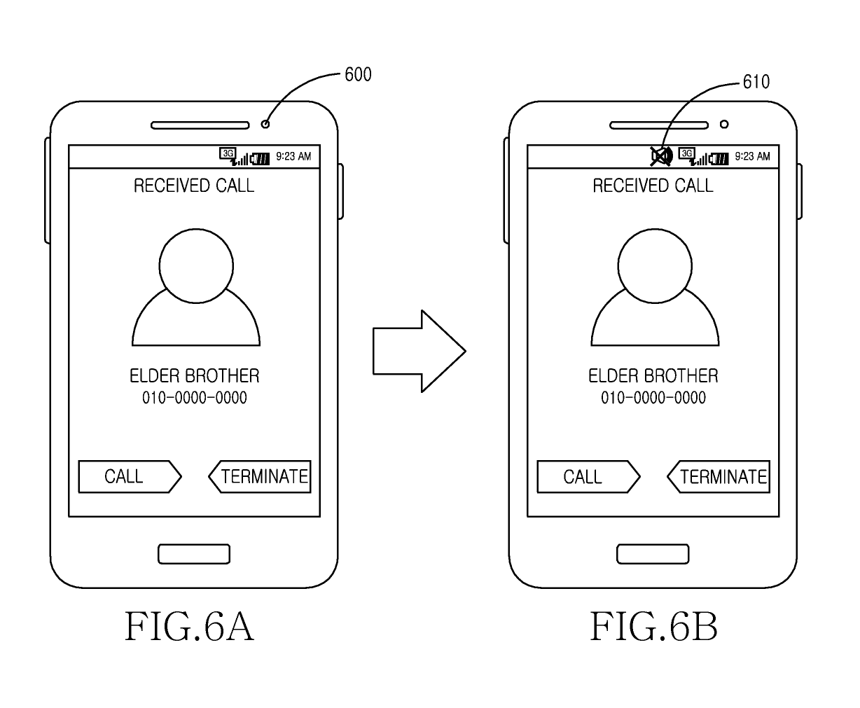

When it is determined that the call is received, the electronic device generates, in step 403, a call reception notifying event according to a preset call reception notifying mode. For example, if the call reception notifying mode is set to a ringtone mode, the electronic device may generate a ringtone. The electronic device may also display a call reception notifying image on the display unit 160 in addition to generating the ringtone, as shown in FIG. 6A. In another example, when the call reception notifying mode is set to a vibration mode, the electronic device may generate a vibration. The electronic device may also display the call reception notifying image on the display unit 160 in addition to the generation of the vibration, as shown in FIG. 6A. In another example, when the call reception notifying mode is set to a silent mode, the electronic device may display only the call reception notifying image on the display unit 160, as shown in FIG. 6A.

In step 405, the electronic device determines whether the call reception notifying mode is set to the silent mode.

When the call reception notifying mode is set to the silent mode, the electronic device proceeds to step 407 and drives a camera to obtain an image for face recognition. For example, the electronic device may activate a first camera 600 included in the camera unit 180, as shown in FIG. 6A, for obtaining an image for face recognition.

In step 409, the electronic device determines whether a face is recognized through the face recognition conducted on the image obtained by the camera. The electronic device may also determine whether the face including the pupils is recognized.

If the face is not recognized in the image obtained through the camera, the electronic device proceeds to step 413 and maintains the call reception notifying event generated in step 403. Although not shown in the drawing, the electronic device may repeat step 409 and continue to determine whether a face is recognized through the face recognition for the image obtained by the camera.

If the face is recognized from the image obtained by the camera, the electronic device recognizes that the user perceives the call reception. Accordingly, the electronic device proceeds to step 411 and changes the call reception notifying mode to the silent mode. For example, the electronic device may change a ringtone or vibration for notifying call reception to silent mode. The electronic device may display a silent icon 610, as shown in FIG. 6B, while the call reception notifying mode operates in the silent mode.

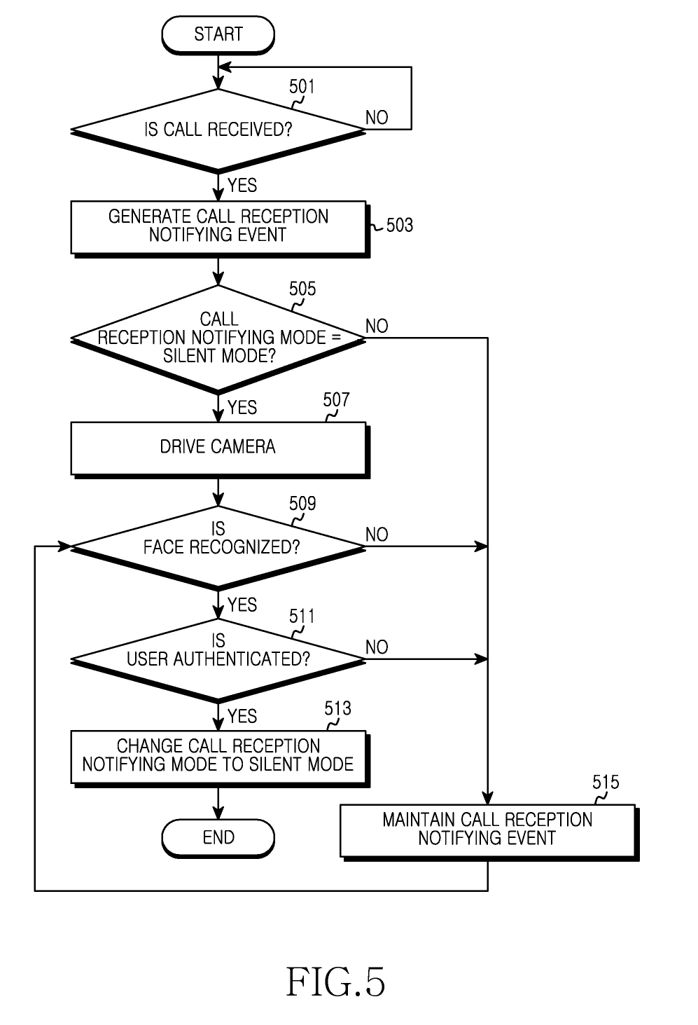

FIG. 5 illustrates a procedure for changing the call reception notifying mode through face recognition in an electronic device according to an embodiment of the present invention.

Referring to FIG. 5, in step 501, the electronic device detects whether a call is received.

When it is determined that the call is received, the electronic device proceeds to step 503 and generates a call reception notifying event according to a preset call reception notifying mode. For example, when the call reception notifying mode is set to a ringtone mode, the electronic device generates a ringtone. In another example, when the call reception notifying mode is set to a vibration mode, the electronic device may generate a vibration. In another example, when the call reception notifying mode is set to a silent mode, the electronic device may only display the call reception notifying image on the display unit 160, as shown in FIG. 6A.

In step 505, the electronic device determines whether the call reception notifying mode is set to the silent mode.

When the call reception notifying mode is not set to the silent mode, the electronic device proceeds to step 515 and maintains the call reception notifying event generated in step 503.

When the call reception notifying mode is set to the silent mode, the electronic device proceeds to step 507, and drives a camera to obtain an image for face recognition. For example, the electronic device may activate the first camera 600 included in the camera unit 180, as shown in FIG. 6A, to obtain an image for face recognition.

In step 509, the electronic device determines whether a face is recognized through the face recognition in an image obtained by the camera. The electronic device may also confirm that a face including the pupils is recognized.

When the face is not recognized from the image obtained by the camera, the electronic device proceeds to step 515 and maintains the call reception notifying event generated in step 503. Although now shown in the drawing, the electronic device may repeat step 509 and continue to determine whether a face is recognized through the face recognition in the image obtained by the camera.

Alternatively, when the face is recognized from the image obtained by the camera, the electronic device proceeds to step 511 and determines whether a user of the electronic device is authenticated through the face recognition. For example, the electronic device may determine whether a face of a user of the electronic device is recognized through the face recognition.

When the user is not authenticated through the face recognition, the electronic device proceeds to step 515 and maintain the call reception notifying event generated in step 503. Then, the electronic device may proceed to step 509 and continue to determine whether a face is recognized through the face recognition from the image obtained by the camera.

When the user of the electronic device is authenticated through the face recognition, the electronic device may recognize that the user perceives the call reception. Accordingly, the electronic device proceeds to step 513 and changes the call reception notifying event to a silent mode. For example, the electronic device may change a ringtone or vibration for notifying the call reception to silence. The electronic device may also display the silent icon 610, as shown in FIG. 6B, while the call reception notifying mode operates in the silent mode.

In the above described embodiments, the electronic device may perform face recognition after generating the call reception notifying event.

In another embodiment, when a call is received (steps 401 or 501), the electronic device may perform (steps 407 to 409, or steps 507 to 511) the face recognition to determine whether to generate the call reception notifying event.

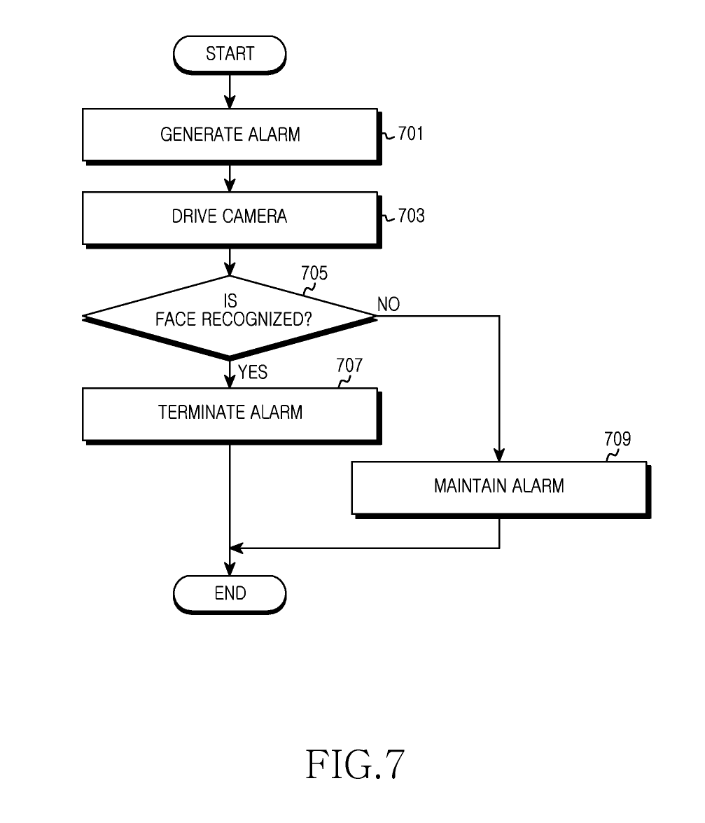

FIG. 7 illustrates a procedure for terminating an alarm through face recognition in an electronic device.

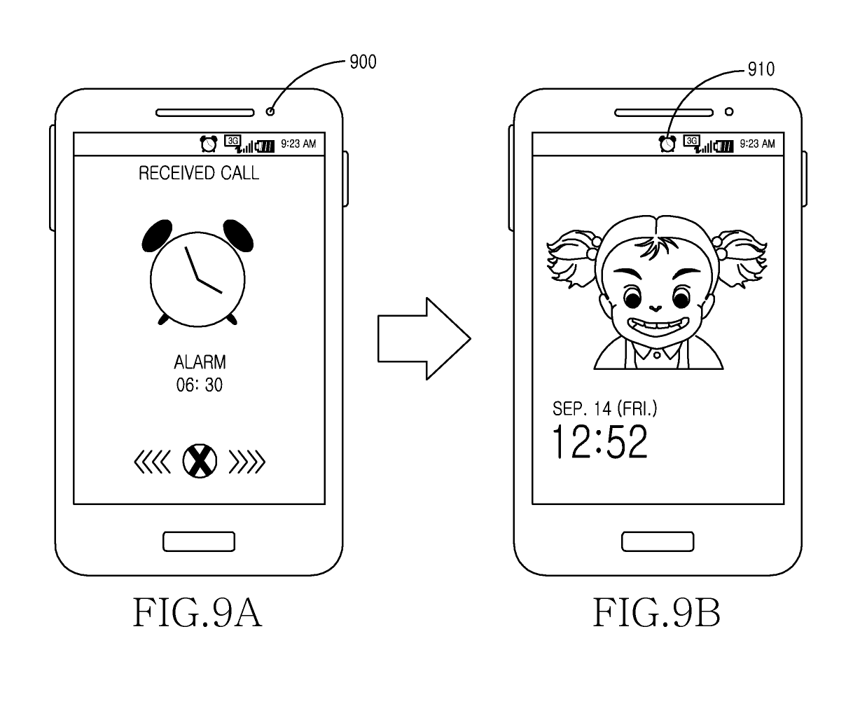

Referring to FIG. 7, when an alarm generating condition is satisfied, the electronic device generates an alarm event in step 701. For example, when it is determined that the current time is equivalent to an alarm time, the electronic device generates an alarm sound. The electronic device may display an alarm generation screen on the display unit 160, as shown in FIG. 9A. In another example, the electronic device generates an alarm sound, when it is near a predetermined position set for alarm generation. The electronic device may also display an alarm generation screen on the display unit 160, as shown in FIG. 9A.

In step 703, the electronic device drives a camera to obtain an image for face recognition. For example, the electronic device may activate a first camera 900 included in the camera unit 180, as shown in FIG. 9A.

In step 705, the electronic device determines whether a face is recognized through the face recognition in an image obtained by the camera. The electronic device may also determine whether a face including the pupils is recognized.

If the face is not recognized from the image obtained by the camera, the electronic device proceeds to step 709 and maintains the alarm event generated in step 701. Although not shown in the drawing, the electronic device may repeat step 705 and continue to determine whether a face is recognized during an alarm duration time through the face recognition in the image obtained by the camera.

Alternatively, when the face is recognized in an image obtained by the camera, the electronic device recognizes that the user perceives the generation of the alarm event. Accordingly, the electronic device proceeds to step 707 and terminates the alarm event generation. For example, the electronic device may terminate generation of an alarm sound, and change an alarm generation screen, as shown in FIG. 9A, to a waiting screen, as shown in FIG. 9B. The electronic device may also display an alarm setting icon 910, as shown in FIG. 9B.

As described above, when a face is recognized in an image obtained by a camera, the electronic device may terminate an alarm event generation. Alternatively, the electronic device may terminate the alarm event generation only when the user is authenticated through the face recognition using the image obtained by the camera.

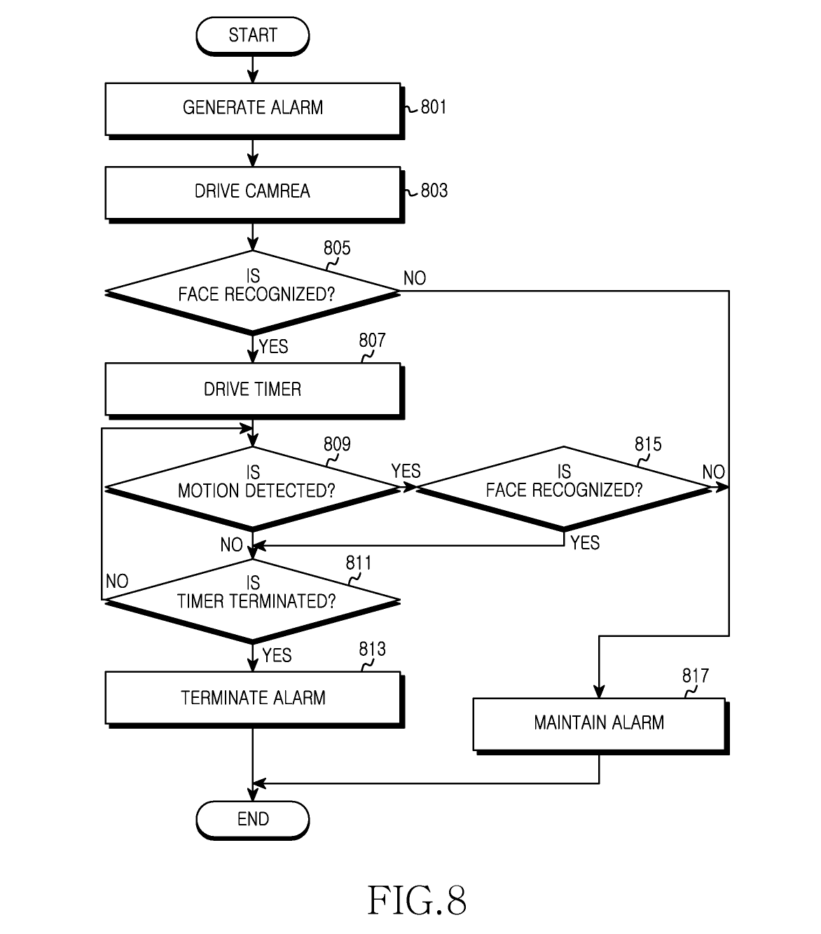

FIG. 8 illustrates a procedure for terminating an alarm through face recognition in an electronic device according to another embodiment of the present invention.

Referring to FIG. 8, when an alarm generating condition is satisfied, the electronic device may generate an alarm event in step 801. For example, when it is determined that the current time is equivalent to an alarm time, the electronic device may generate an alarm sound. The electronic device may display an alarm generation screen on the display unit 160, as shown in FIG. 9A. In another example, the electronic device may generate an alarm sound, when it is near a predetermined position set for alarm generation. The electronic device may also display the alarm generation screen on the display unit 160, as shown in FIG. 9A.

In step 803, the electronic device drives a camera to obtain an image for face recognition. For example, the electronic device may activate the first camera 900 included in the camera unit 180 to obtain an image for face recognition, as shown in FIG. 9A.

In step 805, the electronic device determines whether a face is recognized through face recognition in an image obtained by the camera. The electronic device may also determine whether a face including the pupils is recognized.

If a face is not recognized in the image obtained by the camera, the electronic device proceeds to step 817 and maintains the alarm event generated in step 801. Although not shown in the drawing, the electronic device may repeat step 805 and continue to determine whether a face is recognized during an alarm duration time through the face recognition using the image obtained by the camera.

Alternatively, when a face is recognized in an image obtained by a camera, the electronic device proceeds to step 807 and drives a timer. Here, the timer may be driven for a predetermined time period to determine whether the user perceives the alarm generation.

In step 809, the electronic determines whether a motion of the user is detected. For example, the electronic device may determine whether face recognition information included in the image obtained by the camera has changed.

If the motion of the user is not detected, the electronic device proceeds to step 811 and determines whether driving of the timer is terminated.

Alternatively, if the motion of the user is detected, the electronic device proceeds to step 815 and determines whether a face is recognized through face recognition in the image obtained by the camera. The electronic device may also determine whether a face including the pupils is recognized.

In step 815, if the face is not recognized in the image obtained by the camera, the electronic device proceeds to step 817 and maintains the alarm event generated in step 801. Although not shown in the drawing, the electronic device may repeat step 805 and continue to determine whether the face is recognized through the face recognition in the image obtained by the camera.

Alternatively, in step 815, if the face is recognized in the image obtained by the camera, the electronic device proceeds to step 811 and determines whether the driving of the timer is terminated.

If the driving of the timer is not terminated, the electronic device returns to step 809 and determines whether the motion of the user is detected. For example, the electronic device may determine whether the face recognition information included in the image obtained by the camera has changed.

If the timer is terminated, the electronic device may recognize that the user perceives the generation of the alarm event. Accordingly, the electronic device proceeds to step 813 and terminates the generation of the alarm event. For example, the electronic device may terminate the generation of the alarm event, and change an alarm generation screen, as shown in FIG. 9A, to a waiting screen, as shown in FIG. 9B. The electronic device may also display an alarm setting icon 910 as shown in FIG. 9B.

In the above described embodiments, the electronic device performs face recognition using the image obtained by the camera.

In other embodiments, the electronic device may perform face recognition by using separate sensors for the face recognition.

As described above, the electronic device reduces unnecessary noise generation in a public place without further manipulations from a user by changing a call reception notifying mode to a silent mode or terminating an alarm through face recognition.

It will be appreciated that embodiments of the present invention according to the claims and description above can be realized in the form of hardware, software or a combination of hardware and software. Any such software may be stored in a non-transient computer readable storage medium. The non-transient computer readable storage medium stores one or more programs (software modules), the one or more programs comprising instructions, which when executed by one or more processors in an electronic device, cause the electronic device to perform a method of the present invention. Any such software may be stored in the form of volatile or non-volatile storage such as, for example, a storage device like a Read Only Memory (ROM), whether erasable or rewritable or not, or in the form of memory such as, for example, Random Access Memory (RAM), memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention.

Accordingly, embodiments of the present invention provide a program comprising code for implementing an apparatus or a method as claimed in any one of the appended claims and a machine-readable storage storing such a program. Still further, such programs may be conveyed electronically via any medium such as a communication signal carried over a wired or wireless connection and embodiments suitably encompass the same.

While the present invention has been shown and described with reference to certain embodiments thereof, it will be understood by those skilled in the art that various changes in form and details may be made therein without departing from the spirit and scope of the invention as defined by the appended claims. Therefore, the scope of the invention is defined not by the detailed description of the invention but by the appended claims, and all differences within the scope will be construed as being included in the present invention.

What is claimed is:

1. A method in an electronic device comprising:
determining whether a face is recognized from surroundings of the electronic device when a call is received; and
generating a first call reception event in a first notification mode when the face is recognized from the peripheral images.

2. The method of claim 1, further comprising generating a second call reception event in a second notification mode, when the call is received before determining whether the face is recognized.

3. The method of claim 2, wherein generating the first call reception event comprises,
changing the second call reception event, generated in the second notification mode, to the first call reception event, generated in the first notification mode when the face is recognized from the peripheral images.

4. The method of claim 3, further comprising maintaining the second call reception event generated in the second notification mode when the face is not recognized from surroundings of the electronic device.

5. The method of claim 2, wherein generating the first call reception event comprises,
performing user authentication using face recognition information when the face is recognized from the peripheral image; and
changing the second call reception event, generated in the second notification mode, to the first call reception event, generated in the first notification mode when the user is authenticated.

6. The method of claim 2, wherein the second notification mode includes one of a ringtone mode, a vibration mode, and a silent mode.

7. The method of claim 1, wherein determining whether the face is recognized comprises:
driving a camera;
obtaining images through the camera; and
performing face recognition on the images.

8. The method of claim 1, wherein determining whether the face is recognized comprises,
driving a camera;
obtaining images through the camera; and
determining whether pupils are recognized through face recognition in the images.

9. The method of claim 1, wherein the first notification mode includes a silent mode.

10. The method of claim 1, further comprising:
generating a second call reception event in a second notification mode, when the face is not recognized from surroundings of the electronic device,
wherein the second notification mode includes one of a ringtone mode, a vibration mode, and a silent mode.

11. An electronic device comprising:
a communication system;
a camera; and
at least one processor,
wherein, when a call is received, the processor determines whether a face is recognized from images obtained by the camera, and
wherein, when the face is recognized from the images, the processor generates a first call reception event in a first notification mode.

12. The electronic device of claim 11, wherein, when the call is received, the processor generates a second call reception event in a second notification mode.

13. The electronic device of claim 12, wherein, when the face is recognized from the images, the processor changes the second call reception event, generated in the second notification mode, to the first call reception event, generated in the first notification mode.

14. The electronic device of claim 13, wherein, when the face is not recognized from the images, the processor maintains the second call reception event, generated in the second notification mode.

15. The electronic device of claim 12, wherein, when the face is recognized from the images, the processor performs user authentication by using face recognition information, and
wherein, when the user is authenticated, the processor changes the second call reception event, generated in the second notification mode, to the first call reception event, generated in the first notification mode.

16. The electronic device of claim 12, wherein the second notification mode includes one of a ringtone mode, a vibration mode, and a silent mode.

17. The electronic device of claim 11, wherein, when the call is received, the processor drives the camera to obtain the images and performs face recognition on the images.

18. The electronic device of claim 11, wherein, when the call is received, the processor drives the camera to obtain the images and determines whether pupils are recognized through face recognition in the images.

19. The electronic device of claim 11, wherein the first notification mode includes a silent mode.

20. The electronic device of claim 11, wherein, when the face is not recognized from the images obtained by the camera, the processor generates a second call reception event in a second notification mode, and
wherein the second notification mode includes one of a ringtone mode, a vibration mode, and a silent mode.
